(19) United States
(12) Patent Application Publication
(10) Pub. No.: US 2026/0079432 A1
(43) Pub. Date: Mar. 19, 2026

(54) FIXING DEVICE

(71) Applicant: CANON KABUSHIKI KAISHA, Tokyo (JP)

(72) Inventor: YOUICHI CHIKUGO, Chiba (JP)

(21) Appl. No.: 19/314,047

(22) Filed: Aug. 29, 2025

(30) Foreign Application Priority Data
Sep. 13, 2024 (JP) 2024-159113

(51) Int. Cl. G03G 15/20

(52) U.S. Cl. CPC G03G 15/2053; G03G 15/2064; G03G 2215/2035

(57) ABSTRACT

A sliding member slides on an inner peripheral surface of a belt in a nip portion. A holding member has a recess for holding the sliding member. The recess includes a bottom surface and a downstream side surface. The sliding member is held by the holding member so as to be movable in a direction away from the bottom surface in a state where a nip portion forming member is at the separated position. The holding member has a protrusion portion protruding toward the nip portion at a position upstream of the downstream side surface of the recess. A lowermost point of the protrusion portion is closer to the nip portion than a surface of the sliding member facing the bottom surface in the state where the nip portion forming member is at the separated position.

### BACKGROUND

### Field of the Technology

The present disclosure relates to a fixing device that fixes a toner image borne on a recording material to the recording material.

### Description of the Related Art

As a fixing device, a configuration has hitherto been known in which a nip portion that nips and conveys a recording material is formed by a belt and a nip portion forming member such as a roller, and the recording material passing through the nip portion is heated and pressurized. In a configuration described in JP 2017-181948 A, a nip portion is formed between a belt and a nip portion forming member by causing a sliding member to slide on an inner peripheral surface of the belt in the nip portion.

### SUMMARY

According to one aspect of the present disclosure, a fixing device is configured to fix a toner image borne on a recording material to the recording material. The fixing device includes an endless rotatable belt, a nip portion forming member configured to be brought into contact with an outer peripheral surface of the belt to form a nip portion that nips and conveys the recording material between the nip portion forming member and the belt, a sliding member configured to slide on an inner peripheral surface of the belt in the nip portion, and, a holding member disposed inside the belt so as to sandwich the sliding member and the belt between the holding member and the nip portion forming member, the holding member having a recess for holding the sliding member on a side facing the nip portion. The nip portion forming member is configured to be movable between a contacting position where the nip portion forming member is in contact with the outer peripheral surface of the belt to form the nip portion and a separated position where the nip portion forming member is separated from the outer peripheral surface of the belt. The recess includes a bottom surface, and a downstream side surface formed downstream of the bottom surface in a conveyance direction of the recording material conveyed in the nip portion and facing a downstream end surface in the conveyance direction of the sliding member held in the recess. The sliding member is configured to be held by the holding member so as to be movable in a direction away from the bottom surface in a state where the nip portion forming member is at the separated position. The holding member has a protrusion portion protruding toward the nip portion at a position upstream of the downstream side surface of the recess in the conveyance direction. A lowermost point of the protrusion portion is closer to the nip portion than a surface of the sliding member facing the bottom surface in the state where the nip portion forming member is at the separated position.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross-sectional view illustrating a configuration of an image forming apparatus according to an embodiment.

FIG. 2A is a schematic cross-sectional view illustrating a configuration of a fixing device according to the embodiment.

FIG. 2B is an enlarged schematic view illustrating a portion A in FIG. 2A.

FIG. 3A is a schematic cross-sectional view illustrating a sliding member according to the embodiment.

FIG. 3B is a schematic plan view illustrating the sliding member according to the embodiment.

FIG. 4 is an enlarged schematic cross-sectional view illustrating the vicinity of a nip portion of the fixing device according to the embodiment.

FIG. 5 is a perspective view of the vicinity of end portions in the width direction of a fixing pad and a sliding member as viewed from the sliding member side according to the embodiment.

FIG. 6 is an enlarged schematic cross-sectional view illustrating the vicinity of an exit of the nip portion in a state where a pressure roller is separated from a fixing belt in the fixing device according to the embodiment.

FIG. 7 is an enlarged schematic cross-sectional view illustrating the vicinity of the exit of the nip portion in a state where the pressure roller is in contact with the fixing belt in the fixing device according to the embodiment.

FIG. 8 is an enlarged schematic cross-sectional view illustrating the vicinity of an exit of a nip portion in a state where a pressure roller is separated from a fixing belt in a fixing device according to Comparative Example 1.

FIG. 9 is an enlarged schematic cross-sectional view illustrating the vicinity of an exit of a nip portion in a state where a pressure roller is in contact with a fixing belt in a fixing device according to Comparative Example 2.

### DESCRIPTION OF THE EMBODIMENTS

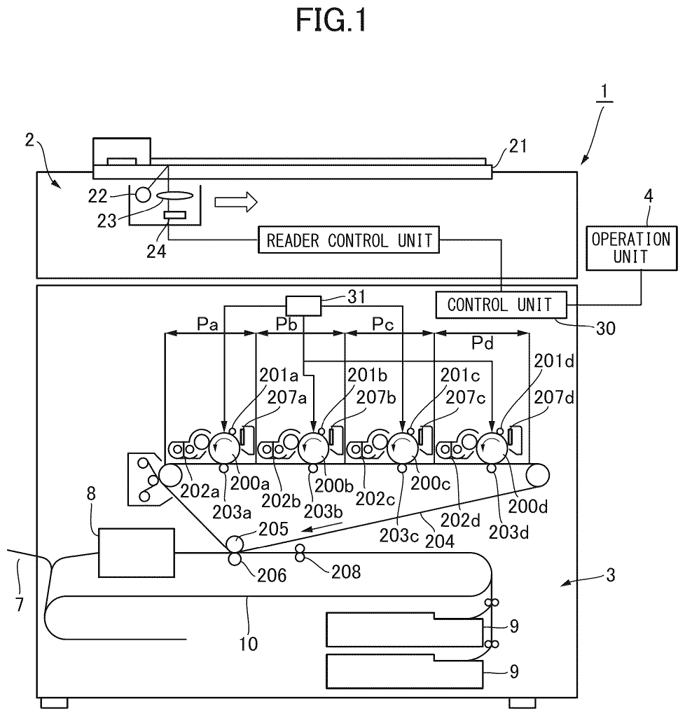

An embodiment will be described with reference to FIGS. 1 to 9. First, a schematic configuration of an image forming apparatus according to the present embodiment will be described with reference to FIG. 1.

### Image Forming Apparatus

The image forming apparatus 1 is an electrophotographic full-color printer including four image forming units Pa, Pb, Pc, and Pd provided to correspond to four colors of yellow, magenta, cyan, and black. In the present embodiment, the image forming units Pa, Pb, Pc, and Pd are arranged in a tandem type along a rotation direction of an intermediate transfer belt 204 to be described below. The image forming apparatus 1 forms a toner image (image) on a recording material according to an image signal from an image reading unit (document reading device) 2 connected to an image forming apparatus body 3 or a host device such as a personal computer communicably connected to the image forming apparatus body 3. Examples of the recording material include sheet materials such as paper, a plastic film, and cloth.

The image forming apparatus 1 includes an image reading unit 2 and an image forming apparatus body 3. The image reading unit 2 reads a document placed on a platen glass 21. Light emitted from a light source 22 is reflected by the document, and an image is formed on a CCD sensor 24 via an optical system member 23 such as a lens. Such an optical system unit converts the document into an electric signal data string for each line by scanning the document in an arrow direction. The image signal obtained by the CCD sensor 24 is sent to the image forming apparatus body 3, and a control unit 30 performs image processing in accordance with each image forming unit to be described below. The control unit 30 also receives an external input from an external host device such as a print server as an image signal.

The image forming apparatus body 3 includes a plurality of image forming units Pa, Pb, Pc, and Pd, and each of the image forming unit forms an image based on the above-described image signal. That is, the image signal is converted into a laser beam subjected to pulse width modulation (PWM) by the control unit 30. A polygon scanner 31 serving as an exposing unit scans the laser beam corresponding to the image signal. Then, photosensitive drums 200a to 200d which serve as image bearing members of the image forming units Pa to Pd are irradiated with a laser beam.

Note that Pa, Pb, Pc, and Pd, which denote an image forming unit for yellow (Y), an image forming unit for magenta (M), an image forming unit for cyan (C), and an image forming unit for black (Bk), respectively, form images of corresponding colors. Since the image forming units Pa to Pd are substantially the same, the image forming unit Pa for Y will be described in detail below, and the description of the other image forming units will be omitted. In the image forming unit Pa, a toner image is formed on a surface of the photosensitive drum 200a based on the image signal as will be described below.

A charging roller 201a serving as a primary charger charges the surface of the photosensitive drum 200a to a predetermined potential to prepare for forming an electrostatic latent image. An electrostatic latent image is formed on the surface of the photosensitive drum 200a charged to the predetermined potential by a laser beam from the polygon scanner 31. A developing unit 202a develops the electrostatic latent image on the photosensitive drum 200a to form a toner image. A primary transfer roller 203a performs discharging from a back surface of the intermediate transfer belt 204, applies a primary transfer bias having a polarity opposite to that of the toner, and transfers the toner image on the photosensitive drum 200a onto the intermediate transfer belt 204. After the transfer, the surface of the photosensitive drum 200a is cleaned by a cleaner 207a.

In addition, the toner image on the intermediate transfer belt 204 is conveyed to the next image forming unit, and toner images for the respective colors formed by the respective image forming units are sequentially transferred in the order of Y, M, C, and Bk, and images of four colors are formed on the surface thereof. Then, the toner image having passed through the image forming unit Pd for Bk located on the most downstream side in the rotation direction of the intermediate transfer belt 204 is conveyed to a secondary transfer portion including a pair of secondary transfer rollers 205 and 206. Then, in the secondary transfer portion, a secondary transfer electric field having a polarity opposite to that of the toner images on the intermediate transfer belt 204 is applied, thereby secondarily transferring the toner images to the recording material.

The recording material is accommodated in a cassette 9, and the recording material fed from the cassette 9 is conveyed to, for example, a registration portion 208 including a pair of registration rollers, and stands by at the registration portion 208. Thereafter, the registration portion 208 conveys the recording material to the secondary transfer portion at a timing controlled to align the toner images on the intermediate transfer belt 204 and the paper.

The recording material to which the toner images have been transferred by the secondary transfer portion is conveyed to a fixing device 8, and the toner images borne on the recording material are fixed to the recording material by being heat-pressurized in the fixing device 8. The recording material having passed through the fixing device 8 is discharged to a sheet discharge tray 7. Note that, in a case where images are formed on both surfaces of the recording material, when toner images are transferred and fixed to a first surface (front surface) of the recording material, the front and back surfaces of the recording material are reversed via a reverse conveyance portion 10, toner images are transferred and fixed to a second surface (back surface) of the recording material, and the recording material is placed on the sheet discharge tray 7.

Note that the control unit 30 controls the entire image forming apparatus 1 as described above. Furthermore, the control unit 30 can perform various settings and the like based on an input from an operation unit 4 included in the image forming apparatus 1. The control unit 30 includes a central processing unit (CPU), a read only memory (ROM), and a random access memory (RAM). The CPU controls each unit while reading a program corresponding to the control procedure stored in the ROM. In addition, work data and input data are stored in the RAM, and the CPU performs control with reference to the data stored in the RAM based on the above-described program or the like.

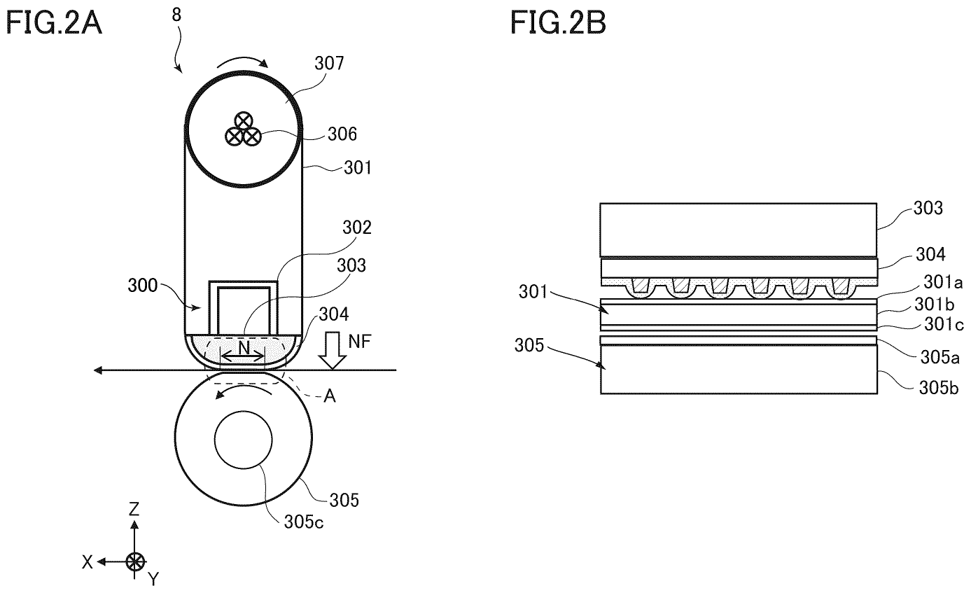

Next, a configuration of the fixing device 8 according to the present embodiment will be described with reference to FIGS. 2A and 2B. In the present embodiment, a belt heating type fixing device using an endless belt is adopted. In FIG. 2A, an X direction represents a conveyance direction of a recording material P (not illustrated in the drawing), a Y direction represents a width direction of the recording material intersecting (in the present embodiment, orthogonal to) the conveyance direction of the recording material, and a Z direction represents a pressure direction in which the recording material is pressed in a nip portion N. In the present embodiment, the X direction, the Y direction, and the Z direction are directions orthogonal to each other.

The fixing device 8 includes a fixing belt (hereinafter, a belt) 301, a stay 302, a fixing pad (hereinafter, a pad) 303, a sliding member 304, a pressure roller 305, a heating roller 307, and the like. The belt 301 is an endless rotatable heating rotary member. The pressure roller 305 serving as a nip portion forming member is a pressure rotary member that comes into contact with an outer peripheral surface of the belt 301 to form a nip portion (fixing nip portion) N that nips and conveys the recording material between the pressure roller 305 and the belt 301. In the present embodiment, the stay 302, the pad 303, and the sliding member 304 constitute a pad unit 300.

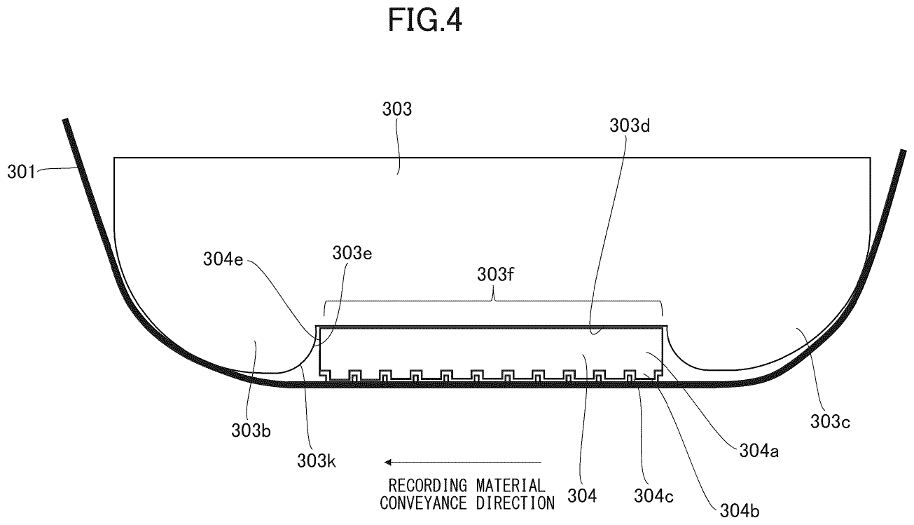

The sliding member 304 slides against an inner peripheral surface of the belt 301 in the nip portion N. The pad 303 serving as a holding member is disposed inside the belt 301 so as to sandwich the sliding member 304 and the belt 301 between the pad 303 and the pressure roller 305, and a fitting groove portion 303f (see FIG. 4, etc. to be described below) serving as a recess for holding the sliding member 304 is formed on a side facing the nip portion N of the pad 303. The sliding member 304 is disposed so as to cover an outer peripheral surface of the pad 303 on the belt 301 side. The stay 302 is disposed inside the belt 301 on a side opposite to the nip portion N with the pad 303 interposed therebetween, and supports the pad 303. The heating roller 307 is disposed inside the belt 301 so as to stretch the belt 301, and heats the belt 301. Hereinafter, each component will be described in detail.

The belt 301 is provided in the pad unit 300 in a replaceable manner. The belt 301 has thermal conductivity, heat resistance, and the like, and has a thin cylindrical shape. In the present embodiment, as illustrated in FIG. 2B, the belt 301 has a three-layer structure in which a base layer 301a, an elastic layer 301b on the outer periphery of the base layer 301a, and a releasable layer 301c on the outer periphery thereof are formed. For the base layer 301a, for example, a polyimide (PI) resin having a thickness of 80 μm is used. For the elastic layer 301b, for example, silicone rubber having a thickness of 300 μm is used. For the releasable layer 301c, for example, PFA (tetrafluoroethylene-perfluoroalkoxyethylene copolymer resin) is used as a fluororesin having a thickness of 30 μm. The belt 301 is stretched by the pad unit 300 and the heating roller 307. The belt 301 has an outer diameter of 150 mm in the present embodiment.

The pressure roller 305 is rotatably supported by a fixing frame (not illustrated) of the fixing device 8, with a gear (not illustrated) fixed to one end in the width direction thereof, and is connected to a driving source (not illustrated) such as a motor via the gear to be rotationally driven. When the pressure roller 305 rotates, a rotational force of the pressure roller 305 is transmitted to the belt 301 by a frictional force generated in the nip portion N. In this manner, the belt 301 is rotated by following the pressure roller 305.

The pressure roller 305 is a roller in which a core metal (shaft) 305c, an elastic layer 305b on the outer periphery of the core metal 305c, and a releasable layer 305a on the outer periphery thereof are formed. For the core metal 305c, for example, stainless steel having a diameter of 72 mm is used. For the elastic layer 305b, for example, conductive silicone rubber having a thickness of 8 mm is used. For the releasable layer 305a, PFA (tetrafluoroethylene-perfluoroalkoxyethylene copolymer resin) is used as a fluororesin having a thickness of 100 μm.

The pressure roller 305 comes into contact with the outer peripheral surface of the belt 301 so as to sandwich the belt 301 between the pressure roller 305 and the sliding member 304, which will be described below, to form a nip portion N that nips and conveys the recording material in the conveyance direction (a direction indicated by arrow X) to fix a toner image on the recording material. The fixing device 8 fixes the toner image onto the recording material P while the recording material P is nipped and conveyed in the nip portion N. For this purpose, the pressure roller 305 is pressed toward the pad unit 300 via the belt 301 by a driving source (not illustrated). In the present embodiment, the pressure roller 305 comes into contact with the belt 301 such that the pressurizing force (NF) in the nip portion N for forming an image is 1600 N, the width of the nip portion N in the X direction (the conveyance direction of the recording material) is 24.5 mm, and the width of the nip portion N in the Y direction (the width direction of the recording material) is 326 mm.

Further, the pressure roller 305 is movable between a contacting position where the pressure roller 305 is in contact with the outer peripheral surface of the belt 301 to form the nip portion N, and a separated position where the pressure roller 305 is separated from the outer peripheral surface of the belt 301. That is, when the pressure roller 305 is moved to the separated position from the contacting position by a driving source (not illustrated), the pressure roller 305 is separated from the belt 301, so that the nip portion N can be released. When the recording material is not passing through the nip portion N, the pressure roller 305 is separated from the belt 301 in order to avoid a temperature rise of the pressure roller 305.

The heating roller 307 is disposed inside the belt 301 to stretch the belt 301 together with the pad unit 300. The heating roller 307 is formed of metal such as aluminum or stainless steel in a cylindrical shape, and a halogen heater 306 serving as a heat source for heating the fixing belt 301 is disposed inside the heating roller 307. Then, the heating roller 307 is heated to a predetermined temperature by the halogen heater 306.

In the present embodiment, the heating roller 307 is formed of, for example, an aluminum pipe having a thickness of 1 mm, from the viewpoint of thermal conductivity. Although one halogen heater 306 may be provided, it is desirable that a plurality of halogen heaters 306 are provided in view of temperature distribution control in a longitudinal direction (rotation axis direction) of the heating roller 307. The plurality of halogen heaters 306 have different light distributions in the longitudinal direction, and the control unit 30 (FIG. 1) controls the lighting ratio according to the size of the recording material. In the present embodiment, three halogen heaters 306 are disposed. Note that the heat source is not limited to the halogen heater, and may be another heater capable of heating the heating roller 307, such as a carbon heater. The belt 301 is heated by the heating roller 307 heated by the halogen heater 306, and is controlled to a predetermined target temperature corresponding to the type of recording material based on a temperature detected by a thermistor (temperature detection member) (not illustrated).

The heating roller 307 may swing with a pivot at one end or in the vicinity of the center in the rotation axis direction (width direction), thereby generating a tension difference between one side and the other side in the width direction of the belt 301, so that the belt 301 can move in the width direction. That is, depending on the accuracy of the outer diameter of the heating roller 307 that stretches the belt 301 and the accuracy of alignment with the pad unit 300 to be described below, the belt 301 may deviate to one of the ends in the width direction during rotation (so-called belt deviation may occur). Therefore, the position (deviation position) of the belt 301 in the rotation axis direction is controlled by swinging the heating roller 307. The heating roller 307 may be biased by a spring supported by the frame (not illustrated) of the fixing device 8 to also serve as a tension roller that applies a predetermined tension to the belt 301. In addition, a gear (not illustrated) may be fixed to one end in the width direction of the heating roller 307, and the heating roller 307 may be connected to a driving source (not illustrated) such as a motor via the gear to also serve as an auxiliary driving roller that applies a driving force to the belt 301 when the heating roller 307 is rotationally driven.

### Pad Unit

Next, the pad unit 300 will be described with reference to FIGS. 2A to 4. The pad unit 300 includes the stay 302, the pad 303, and the sliding member 304, which are disposed on an inner peripheral side of the belt 301. The stay 302 serving as a support member is, for example, a metal rigid member extending in the width direction along the belt 301. The stay 302 is disposed on a side opposite to the nip portion N with the pad 303 interposed therebetween, and supports the pad 303. In the present embodiment, the pad 303 supported by the stay 302 is pressurized by the pressure roller 305 from the outer peripheral side of the belt 301. As a result, the nip portion N that is a wide nip of which a length in conveyance direction and a length in width direction are secured is formed between the pressure roller 305 and the belt 301. In addition, by supporting the resin pad 303 on the metal stay 302 having higher rigidity than the pad 303, the deflection that occurs in the pad 303 due to pressure when the pad 303 is pressurized is reduced, making it possible to obtain a uniform nip width in the width direction.

The pad 303 serving as a holding member is non-rotatably provided inside the belt 301, has a fitting groove portion 303f as a recess into which the elongated sliding member 304 can be fitted, and holds the sliding member 304 so as to be in contact with the inner peripheral surface of the belt 301. In the present embodiment, the pad 303 is a substantially plate-like member that is long along the width direction of the belt 301 (a longitudinal direction intersecting the rotation direction of the belt 301 and a rotation axis direction of the heating roller 307). The pad 303 has a length in the width direction longer than a length in the width direction of a maximum-size recording material on which an image can be formed. The pad 303 is formed of, for example, a resin having good insulating properties and heat resistance, such as a liquid crystal polymer (LCP) resin. The pad 303 is a molded product manufactured from such a resin by injection molding using a mold. The sliding member 304 is interposed between the pad 303 and the belt 301. The sliding member 304 will be described in detail below.

As illustrated in FIG. 4, the fitting groove portion 303f of the pad 303 has a bottom surface 303d and a downstream side surface 303e formed downstream of the bottom surface 303d in the conveyance direction of the recording material conveyed in the nip portion and facing a downstream end surface 304e in the conveyance direction of the sliding member 304 held in the fitting groove portion 303f. The pad 303 has, in the conveyance direction, an upstream side guide portion 303c contacting the belt 301 at a position upstream of the bottom surface 303d of the fitting groove portion 303f, and a downstream side guide portion 303b contacting the belt 301 at a position downstream of the bottom surface 303d. The bottom surface 303d is a surface in contact with a side opposite to a sliding surface of the sliding member 304 (a distal end of a convex portion). The upstream side guide portion 303c is an upstream side guide surface that guides the belt 301 toward the nip portion N. The downstream side guide portion 303b is a downstream side guide surface that guides the belt 301 that have passed through the nip portion N toward the stay 302 side so as to move away from the nip portion N. That is, the downstream side guide portion 303b is formed downstream of the downstream side surface 303e of the fitting groove portion 303f in the conveyance direction, and guides the belt 301 downstream in the rotation direction of the belt 301. The upstream side guide portion 303c and the downstream side guide portion 303b contact the belt 301 over the entire passage region in the width direction through which a maximum-size recording material on which an image can be formed passes in the nip portion N.

### Sliding Member

When the frictional force between the belt 301 and the pad 303 is large, the rotation of the belt 301 is hindered. Therefore, in the present embodiment, as illustrated in FIG. 4, in order to reduce the frictional force between the belt 301 and the pad 303 in the nip portion N where the pressure is high, the pad 303 is provided with the sliding member 304 that slides against the belt 301. The sliding member 304 is disposed at a position facing the pressure roller 305 with the belt 301 interposed therebetween while being held by the pad 303. In the present embodiment, the sliding member 304 is held by the pad 303 such that the lateral direction is the conveyance direction.

The sliding member 304 has heat resistance and strength, and has a sliding surface comes into contact with the inner peripheral surface of the belt 301 that is rotating and slides against the belt 301 while being held by the pad 303. By interposing the sliding member 304 between the pad 303 and the belt 301, the frictional force between the pad 303 and the belt 301 is reduced, and the pad 303 does not hinder the rotation of the belt 301. A lubricant may be applied to the inner peripheral surface of the belt 301 in order to cause the belt 301 to smoothly slide on the sliding member 304. As the lubricant, for example, silicone oil or the like is used.

As described above, in the present embodiment, the frictional force between the pad 303 and the belt 301 is reduced by the sliding member 304. In the sliding member 304 of the present embodiment, as illustrated in FIG. 2B, a plurality of projections are formed on the sliding surface that slides against the belt 301. The sliding member 304 is formed using metal such as stainless steel (SUS), copper, or aluminum. Since the sliding member 304 comes into contact with the belt 301 to be heated, it is desirable that the thermal capacity of the sliding member 304 is small. Therefore, in the present embodiment, the sliding member 304 is formed using stainless steel (SUS) having a thickness of “1 mm”. The sliding member 304 may be formed using engineering plastic such as a polyimide (PI) resin, a polyether ether ketone (PEEK) resin, or a liquid crystal polymer (LCP) resin, not limited to the metal.

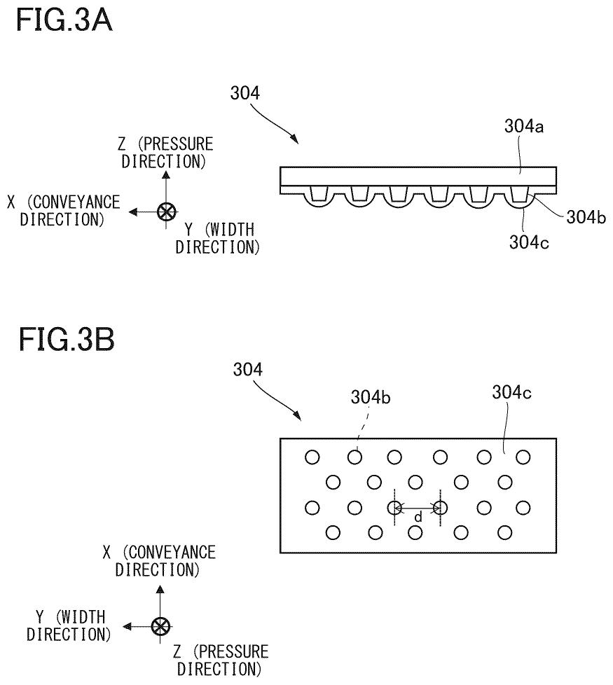

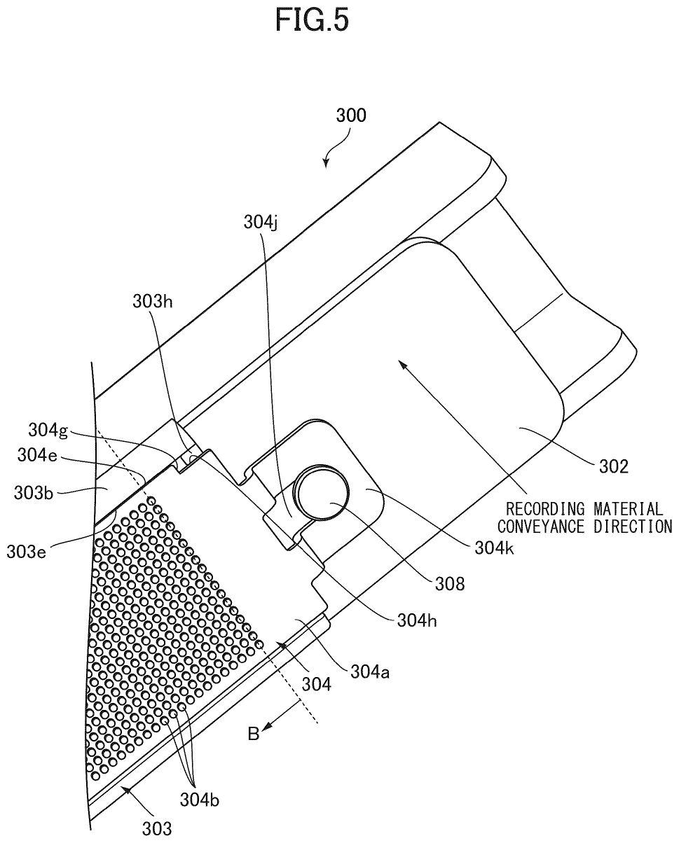

A detailed configuration of the sliding member 304 is illustrated in FIGS. 3A and 3B. FIG. 3A is a cross-sectional view of the sliding member 304 when cut in the conveyance direction, and FIG. 3B is a plan view of the sliding member 304 when viewed from a side on a plane where the belt 301 and the sliding member 304 contact each other. As will be described in detail below, the sliding member 304 is fixed to the stay 302 via the pad 303 by a fastening member such as a stepped screw 308 (FIG. 5). The sliding member 304 includes a plate-shaped base 304a and a sliding layer 304c. A plurality of projections (convex portions) 304b protruding toward the inner peripheral surface of the belt 301 is formed on a side of the base 304a sliding against the belt 301. The sliding layer 304c is provided so as to cover a surface (including the plurality of projections 304b) on a side sliding against the belt 301 of the base 304a.

As illustrated in FIG. 3A, the plurality of projections 304b are provided so as to protrude from the base 304a toward the inner peripheral surface of the belt 301. The plurality of projections 304b protrude from the surface of the base 304a, for example, by “250 μm” (height in the Z direction). In addition, as illustrated in FIG. 3B, the plurality of projections 304b are integrally formed of the same material as the base 304a, and are arranged in the nip portion N across the conveyance direction (X direction) of the recording material and across the width direction (Y direction) of the recording material intersecting the conveyance direction. The distance (interval) d between the centers of the projections 304b adjacent to each other in the conveyance direction and the distance (interval) d between the centers of the projections 304b adjacent to each other in the width direction are 1.25 mm or more, preferably 1.4 mm or more. In the present embodiment, in order to make slidability on the belt 301 uniform, the intervals between the plurality of projections 304b are the same in the conveyance direction and in the width direction, and each interval d being 1.4 mm.

By providing the plurality of projections 304b on the surface (sliding surface) of the sliding member 304 on the side sliding against the belt 301 in this manner, the contact area between the sliding member 304 and the belt 301 is reduced, and the sliding resistance between the sliding member 304 and the belt 301 is reduced. The sliding layer (low friction layer) 304c is preferably formed of a coating material for achieving low friction such as a fluororesin (polytetrafluoroethylene (PTFE), PFA, etc.). In the present embodiment, the sliding member 304 is formed by coating the surface of the base 304a including the plurality of projections 304b with PTFE having a thickness of 20 μm.

As illustrated in FIG. 4, in the present embodiment, a convex shape is formed on the surface of the sliding member 304, and the sliding member 304 slides against the belt 301 on distal end surfaces of the plurality of projections 304b. As a result, the contact area between the sliding member 304 and the belt 301 is reduced, and the frictional force between the sliding member 304 and the belt 301 is reduced. In addition, since the surfaces of the plurality of projections 304b are coated with the sliding layer 304c as described above, which also reduces the frictional force between the sliding member 304 and the belt 301.

### Holding of Sliding Member

As described above, the pad 303 holds the sliding member 304 such that the inner peripheral surface of the belt 301 slides on the distal end surfaces of the plurality of projections 304b. In the present embodiment, a fitting groove portion 303f having a concave shape for fitting and holding the sliding member 304 is formed on a side of the pad 303 opposite to the side supported by the stay 302. The sliding member 304 is held by the pad 303 so as to be movable in a direction away from the bottom surface 303d of the fitting groove portion 303f in a state where the pressure roller 305 is at the separated position.

FIG. 5 is a partial perspective view for explaining a relationship between the pad 303 and the sliding member 304. The belt 301 (not illustrated in FIG. 5) comes into contact with and slides on the sliding member 304 in a range indicated by B in the drawing. The sliding member 304 is fastened to the stay 302 by the stepped screw 308 serving as a fastening member on an outer side in the width direction of a region where the sliding member 304 slides against the belt 301.

An attachment portion 304k is provided at an end portion in the width direction of the base 304a of the sliding member 304. The attachment portion 304k is bent from the end portion of the base 304a toward a side opposite to the belt 301 and bent outward in the width direction to form a step with respect to the base 304a. A slit 304j is formed in the attachment portion 304k, and the attachment portion 304k is fastened to the stay 302 by inserting the stepped screw 308 into the slit 304j and screwing the stepped screw 308 into a screw hole formed in the stay 302.

The attachment portion 304k has a step with respect to the base 304a of the sliding member 304 as described above, and is fastened to the stay 302 at a position farther from the belt 301 in a height direction than the base 304a. Here, the height direction is a direction orthogonal to the conveyance direction of the recording material and orthogonal to the width direction, and is the above-described Z direction. By forming the attachment portion 304k with a step with respect to the base 304a in this manner, the stepped screw 308 can be attached at a position away from the belt 301, and it is possible to perform work without removing the stepped screw 308 at the time of assembling or disassembling the belt 301 to or from the pad unit 300.

The sliding member 304 is fastened to the stay 302 by the stepped screw 308 with a gap in the height direction through the slit 304j formed in the attachment portion 304k. That is, by using the stepped screw 308 as a member for fastening the sliding member 304 to the stay 302, the sliding member 304 is movable in the height direction with respect to the stay 302 by a gap between the stepped screw 308 and the attachment portion 304k. Further, the stepped screw 308 is loosely fitted into the slit 304j, and is thereby fastened to the stay 302 with a gap in the conveyance direction and the width direction of the recording material. Therefore, the sliding member 304 is movable in the conveyance direction and the width direction with respect to the stay 302 by the gap between the stepped screw 308 and the slit 304j.

The reason why the sliding member 304 is movable in the height direction, the conveyance direction, and the width direction with respect to the stay 302 in this manner is that the pad 303 and the sliding member 304 are made of different materials and have different thermal expansion coefficients. For example, when the fixing device 8 is used, the belt 301 is heated, and accordingly, the temperatures of the pad 303 and the sliding member 304 rise, and each of these members thermally expands. In the present embodiment, the difference in thermal expansion at this time is absorbed by the above-described configuration. In addition, tolerances of the sliding member 304, the pad 303, and the stay 302 are also absorbed by the above-described configuration. Note that the sliding member 304 may not be fastened to the stay 302 as long as the sliding member 304 is configured to be prevented from coming off so as to have backlash in the height direction with respect to the pad 303.

When the nip portion N is formed, that is, when the pressure roller 305 is located at the contacting position, the belt 301 slides on the plurality of projections 304b of the sliding member 304 as the pressure roller 305 rotates. As a result, the sliding member 304 receives a sliding force from the belt 301 in a downstream direction with respect to the conveyance direction of the recording material. At this time, since the sliding member 304 is fastened to the stay 302 so as to be movable in the conveyance direction of the recording material, the sliding member 304 moves downstream in the conveyance direction of the recording material due to the sliding force received from the belt 301, and the downstream end surface 304e of the sliding member 304 comes into contact with the downstream side surface 303e of the fitting groove portion 303f formed in the pad 303 (see FIG. 4). As a result, the position of the sliding member 304 in the conveyance direction of the recording material with respect to the pad 303 is determined. That is, in a state where the pressure roller 305 is located at the contacting position, the downstream end surface 304e come into contact with the downstream side surface 303e of the fitting groove portion 303f, whereby the sliding member 304 is restricted from moving downstream in the conveyance direction. Even in a state where the nip portion N is formed, as long as a protrusion portion 303h and a contact portion 304h to be described below contact each other, the downstream end surface 304e and the downstream side surface 303e do not need to contact each other.

As illustrated in FIG. 4, the downstream side surface 303e of the fitting groove portion 303f is formed continuously with the downstream side guide portion 303b with a corner portion 303k having an arcuate cross section interposed therebetween. As a result, the belt 301 is continuously brought into contact with and guided by the sliding member 304 and the pad 303. Specifically, the belt 301 is stretched between the plurality of projections 304b of the sliding member 304 and the downstream side guide portion 303b in a state where the pressure roller 305 is located at the contacting position. In the present embodiment, the recording material is peeled off from the belt 301 by a curvature of the belt 301 curved by a corner portion of a projection 304b located at the most downstream position in the conveyance direction of the recording material among the plurality of projections 304b.

### Prevention of Sliding Member from Falling Off

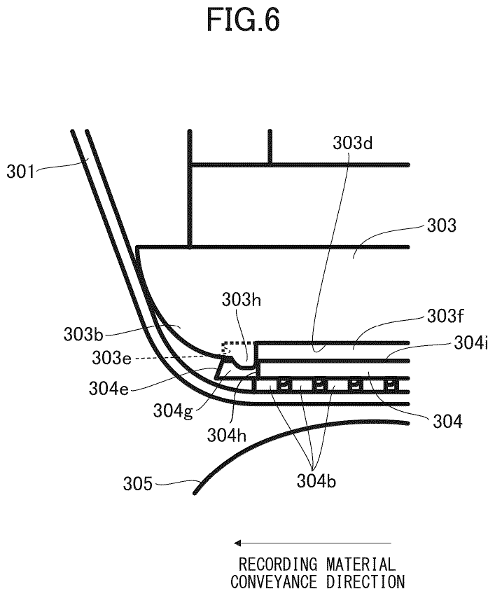

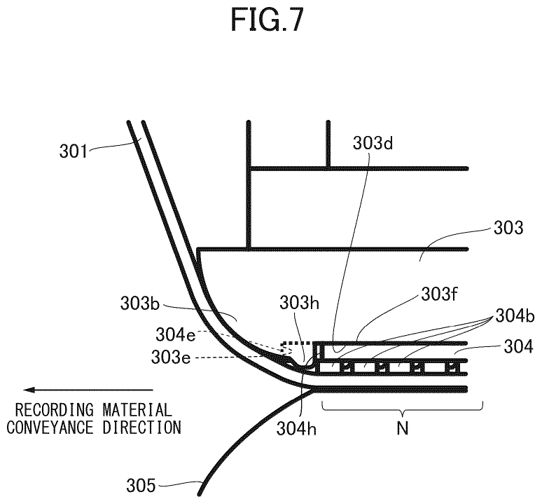

Next, a configuration for preventing the sliding member 304 from falling off in the present embodiment will be described with reference to FIGS. 6 and 7 in addition to FIG. 5 described above. FIG. 6 is a cross-sectional view of the vicinity of the exit of the nip portion N when the pressure roller 305 is separated from the outer peripheral surface of the belt 301 to release the nip portion N. FIG. 7 is a cross-sectional view of the vicinity of the exit of the nip portion N when the pressure roller 305 comes into contact with the outer peripheral surface of the belt 301 to form the nip portion N.

As described above, the sliding member 304 is held with a gap in the height direction with respect to the pad 303 in order to avoid expansion and deformation due to thermal expansion. Therefore, when the nip portion N is released, the sliding member 304 may maintain contact with the belt 301 and move in a direction away from the pad 303. That is, when the pad 303 is separated from the belt 301, the belt 301 is bent in a direction away from the pad 303 due to gravity, and the sliding member 304 falls with respect to the pad 303 due to gravity by the gap between the attachment portion 304k of the sliding member 304 and the stepped screw 308.

At this time, if the sliding member 304, which is a thin plate having a thickness of about 1 mm, falls from the fitting groove portion 303f, the sliding member 304 may ride on the downstream side guide portion 303b of the pad 303 due to the frictional force received from the belt 301. The belt 301 is guided along the corner portions of the plurality of projections 304b of the sliding member 304 and the downstream side guide portion 303b to peel off a recording material on which a toner image is formed, and thus, there is a concern that an abnormality such as a failure in peeling off the recording material may occur due to the ride-on. In addition, since the belt 301 always receives heat from the heating roller 307, the belt 301 is driven in the conveyance direction even when the nip portion N is released. By driving the belt when the nip portion N is released, heat unevenness of the belt does not occur. On the other hand, since the belt rotates, the sliding member 304 rides on the fitting groove portion 303f in the conveyance direction. Therefore, in the present embodiment, the protrusion portion (restricting portion) 303h protruding toward the nip portion is provided on a downstream side in the conveyance direction of the pad 303, and the protrusion portion 303h is brought into contact with the contact portion (downstream end portion) 304h formed on a downstream side in the conveyance direction of the sliding member 304, thereby restricting the sliding member 304 from moving downstream in the conveyance direction even if the sliding member 304 falls.

That is, the pad 303 includes a protrusion portion 303h protruding toward the nip portion at a position upstream of the downstream side surface 303e of the fitting groove portion 303f in the conveyance direction, and formed so as not to protrude toward the nip portion beyond the sliding member 304 in a state where the pressure roller 305 is located at the contacting position (the state of FIG. 7). The lowest point of the protrusion portion 303h on the nip portion side is closer to the nip portion than a contact surface 304i of the sliding member 304 facing the bottom surface 303d. On the other hand, the sliding member 304 has a contact portion 304h disposed upstream of the protrusion portion 303h in the conveyance direction, and brought into contact with the protrusion portion 303h in a state where the pressure roller 305 is located at the separated position (the state of FIG. 6), thereby restricting the sliding member 304 from moving downstream in the conveyance direction.

In the present embodiment, as illustrated in FIG. 5, the sliding member 304 has a cut-out portion 304g cut out upstream in the conveyance direction from a downstream end. A part of the cut-out portion 304g, specifically, an edge portion facing downstream in the conveyance direction, among the edges forming the cut-out portion 304g, serves as a contact portion 304h. The cut-out portion 304g is formed at a downstream end portion in the conveyance direction and at an end portion in the width direction of the sliding member 304. In other words, by cutting out the end portion in the width direction at the downstream end portion in the conveyance direction of the base 304a of the sliding member 304, the contact portion 304h that can be brought into contact with the protrusion portion 303h is formed upstream of the downstream end surface 304e of the sliding member 304 in the conveyance direction. Such a contact portion 304h is provided outside a region where the plurality of projections 304b are formed in the width direction.

On the other hand, the protrusion portion 303h formed in the pad 303 is provided at an end portion of the pad 303 in the width direction, and is located downstream of a part of the cut-out portion 304g, which is the contact portion 304h, in the conveyance direction. That is, the protrusion portion 303h is provided so as to enter the cut-out portion 304g formed in the sliding member 304. In addition, a height of the protrusion portion 303h from the bottom surface 303d of the fitting groove portion 303f (a distance in the height direction between the bottom surface 303d and a distal end of the protrusion portion 303h) is larger than a height of an upstream end of the downstream side guide portion 303b in the conveyance direction from the bottom surface 303d (a distance in the height direction between the bottom surface 303d and the upstream end of the downstream side guide portion 303b in the conveyance direction). As a result, even when the nip portion N is released and the sliding member 304 falls from the fitting groove portion 303f, the protrusion portion 303h can be placed at a position where the protrusion portion 303h can more reliably contact the contact portion 304h.

In the present embodiment, by forming the cut-out portion 304g at a downstream end of the sliding member 304 and bringing the contact portion 304h, which is a part of the cut-out portion 304g, into contact with the protrusion portion 303h formed in the pad 303 in this manner, even when the sliding member 304 falls from the fitting groove portion 303f and attempts to move downstream in the conveyance direction, this movement can be restricted. That is, it is possible to suppress the sliding member 304 from falling off. In the above-described example, the cut-out portion 304g is formed in the sliding member 304 in order to provide the contact portion 304h. However, for example, a through hole or a groove into which the protrusion portion 303h can enter may be formed at a position upstream of the downstream side surface 303e of the pad 303 in the conveyance direction in a part of the sliding member 304, and an inner wall of the through hole or the groove may serve as the contact portion 304h.

In addition, the above-described cut-out portions 304g are formed by cutting out the corner portions at both end portions in the width direction and the downstream end portion in the conveyance direction of the sliding member 304. Similarly, the protrusion portions 303h are formed in a shape continuous from the downstream side guide portion 303b downstream in the conveyance direction at both end portions in the width direction of the pad 303. Therefore, the contact portions 304h, which are parts of the cut-out portions 304g at both end portions in the width direction of the sliding member 304, are brought into contact with the protrusion portions 303h of the pad 303, thereby restricting the sliding member from moving downstream in the conveyance direction even when the sliding member 304 falls.

On the other hand, as illustrated in FIG. 7, when the nip portion N is formed, the sliding member 304 is pressed toward the pad 303 by the pressure roller 305 via the belt 301. As described above, the protrusion portion 303h is formed so as not to protrude toward the nip portion beyond the sliding member 304 in a state where the pressure roller 305 is located at the contacting position (a state where the nip portion N is formed). In the present embodiment, the cut-out portion 304g is formed at an end portion within a range in which the sliding member 304 slides against the belt 301, and the contact portion 304h is formed upstream of the downstream side surface 303e of the sliding member 304 in the conveyance direction of the recording material.

Here, it is conceivable to form the cut-out portion 304g outside the range in which the sliding member 304 slides against the belt 301, but in this case, the length of the sliding member 304 in the width direction increases. Then, in order to prevent interference with other members present outside the sliding member 304 in the width direction, it is necessary to dispose the other members further outward of the sliding member 304 in the width direction, which may result in an increase in the size of the device. Therefore, in the present embodiment, the cut-out portion 304g is formed within a range where the sliding member 304 slides against the belt 301. Therefore, the protrusion portion 303h contacting the contact portion 304h of the cut-out portion 304g is also located within the range in which the sliding member 304 slides against the belt 301. Therefore, in the present embodiment, the protrusion portion 303h is formed upstream of the downstream side surface 303e of the pad 303 in the conveyance direction, and in a state where the nip portion N is formed, the protrusion portion 303h is prevented from contacting the inner peripheral surface of the belt 301 stretched between the plurality of projections 304b and the downstream side guide portion 303b.

That is, the protrusion portion 303h of the pad 303 is formed upstream of the downstream side guide portion 303b in the conveyance direction so as to face the contact portion 304h of the sliding member 304. In addition, by forming the contact portion 304h upstream of the downstream side surface 303e in the conveyance direction, the contact portion 304h is located at a position away from the downstream side guide portion 303b. Therefore, the protrusion portion 303h and the contact portion 304h can be arranged at a position further retracted from the trajectory of the belt 301 stretched between the plurality of projections 304b and the downstream side guide portion 303b. As a result, it is possible to suppress the protrusion portion 303h from coming into contact with the belt 301, and thus, it is possible to suppress the protrusion portion 303h from exerting stress on the belt 301, such as deformation or pressure collection due to contact.

### Arrangement of Protrusion Portion

In the present embodiment, as described above, the sliding member 304 is fastened to the stay 302 with a gap therebetween via the stepped screw 308. Therefore, when the nip portion N is formed, the downstream end surface 304e comes into contact with the downstream side surface 303e of the pad 303 due to the frictional force received by the sliding member 304 from the belt 301. As a result, the pressure distribution in the lateral direction of the nip portion N is continuously formed, which is a suitable arrangement for preventing image defects and the like caused by a drop in nip pressure.

On the other hand, since the cut-out portion 304g is formed in the sliding member 304 in order to form the contact portion 304h to be brought into contact with the protrusion portion 303h at the end portion of the pad 303 where the protrusion portion 303h is provided, a gap is created between the pad 303 and the sliding member 304. Here, when the cut-out portion 304g is formed within a region (passage region) where the recording material passes through the nip portion N, a gap exists between the pad 303 and the sliding member 304 in the passage region. In this case, pressure is released through this gap, or water vapor generated by heating the recording material is accumulated in this gap, which may affect an image fixed onto the recording material when the recording material passes through the nip portion N, resulting in an image defect. Therefore, it is desirable that the protrusion portion 303h and the contact portion 304h be disposed at an end portion in the longitudinal direction and outside the maximum width of the recording material that can be handled by the fixing device 8.

That is, in the present embodiment, the protrusion portion 303h is provided outside a region where a maximum-size recording material passes through the nip portion N in the width direction. In the present embodiment, the maximum-size recording material that passes through the fixing device 8 has a width of 330.2 mm, and the protrusion portion 303h and the contact portion 304h are formed outside a position in the width direction of 170 mm from the center in the width direction of the recording material.

### COMPARATIVE EXAMPLE

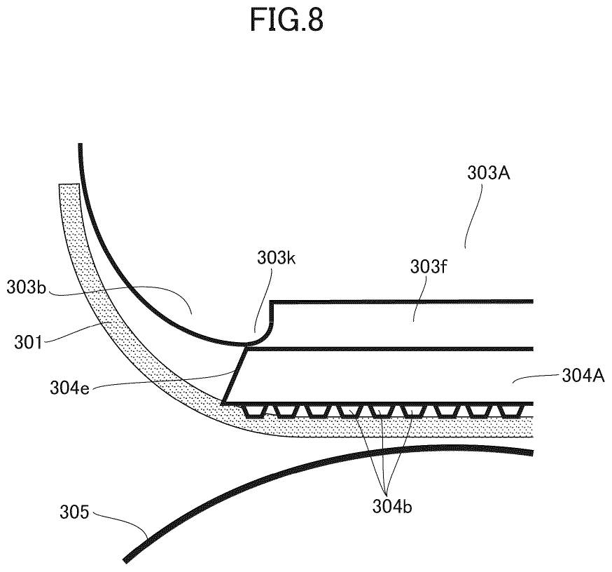

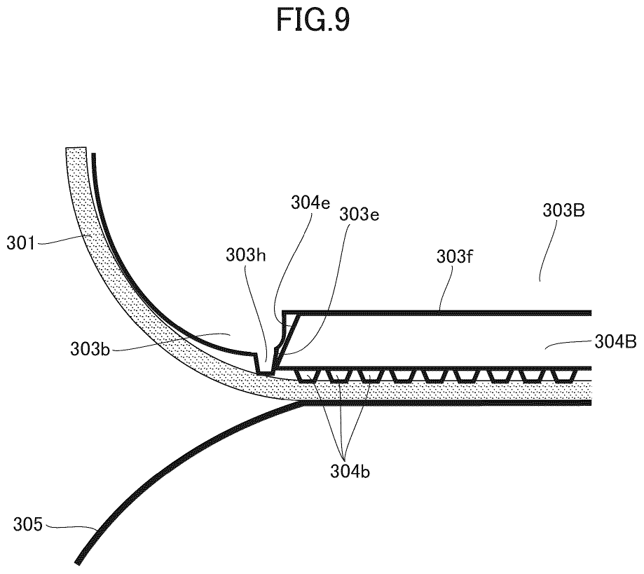

Next, the configurations of Comparative Examples 1 and 2 for explaining the effects of the present embodiment will be described with reference to FIGS. 8 and 9. Comparative Example 1 illustrated in FIG. 8 is an example in which a configuration for restricting a sliding member 304A from falling off is not formed in a pad 303A, and the sliding member 304A falls off and rides on the downstream side guide portion 303b of the pad 303A. Unlike the configuration of the present embodiment described above, Comparative Example 1 has a configuration in which the protrusion portion 303h is not formed in the pad 303A and the contact portion 304h is not formed in the sliding member 304A. The other configurations are the same as those in the above-described present embodiment. FIG. 8 is a cross-sectional view for explaining a positional relationship between the pad 303A and the sliding member 304A in a state where the pressure roller 305 is separated from the belt 301 and the nip portion N is released.

When the nip portion N is released, the sliding member 304A is separated from the bottom surface 303d of the pad 303A. At this time, by receiving the frictional force from the belt 301, the downstream end surface 304e of the sliding member 304A moves to a position downstream in the conveyance direction of the corner portion 303k having an arcuate cross section and continuous from the downstream side surface 303e of the fitting groove portion 303f formed in the pad 303A. In this state, when the nip portion N is formed again, the sliding member 304A cannot return to the fitting groove portion 303f, and the sliding member A falls off onto the downstream side guide portion 303b at a position downstream of the corner portion 303k.

In contrast, in the present embodiment, when the nip portion N is released, the protrusion portion 303h formed in the pad 303 comes into contact with the contact portion 304h of the sliding member 304, so that the downstream end surface 304e of the sliding member 304 can be positioned upstream in the conveyance direction of the corner portion 303k having an arcuate cross section. As a result, even when the nip portion N is released, it is possible to suppress the sliding member 304 from falling off.

Next, Comparative Example 2 illustrated in FIG. 9 is an example in which a protrusion portion 303h of a pad 303B is formed at a position in contact with a downstream end surface 304e of a sliding member 304B. In Comparative Example 2, unlike the configuration of the present embodiment described above, the protrusion portion 303h of the pad 303B is positioned downstream of the downstream side surface 303e of the fitting groove portion 303f in the conveyance direction, the contact portion 304h is not formed in the sliding member 304B, and the protrusion portion 303h is brought into contact with the downstream end surface 304e of the sliding member 304B. The other configurations are the same as those in the above-described present embodiment. FIG. 9 is a cross-sectional view for explaining a positional relationship between the pad 303B and the sliding member 304B in a state where the pressure roller 305 is in contact with the belt 301 and the nip portion N is formed.

In Comparative Example 2, a protrusion portion 303h is formed by extending an end portion of the downstream side surface 303e of the pad 303B toward the nip portion N, and the protrusion portion 303h is brought into contact with the downstream end surface 304e of the sliding member 304B, thereby preventing the sliding member 304B from falling off from the fitting groove portion 303f. However, since the protrusion portion 303h is located downstream of the downstream side surface 303e in the conveyance direction, when the nip portion N is formed, the protrusion portion 303h comes into contact with the inner peripheral surface of the belt 301, causing stress such as stress concentration due to local deformation of the belt 301, which may result in a short lifespan of the belt 301.

In contrast, in the present embodiment, by forming the protrusion portion 303h upstream of the downstream side surface 303e in the conveyance direction, the protrusion portion 303h can be placed with a gap secured from the belt 301 guided by the plurality of projections 304b of the sliding member 304 and the downstream side guide portion 303b of the pad 303. Therefore, it is possible to suppress excessive stress from being applied to the belt 301. In this manner, in the present embodiment, it is possible to suppress the sliding member 304 from falling off, and it is also possible to suppress the belt 301 from experiencing excessive stress.

### OTHER EMBODIMENTS

In the above-described embodiment, the configuration in which the sliding member 304 is fitted into the fitting groove portion 303f of the pad 303 has been described. However, as long as the protrusion portion 303h and the contact portion 304h have the above-described relationship, a member may be sandwiched between the pad 303 and the sliding member 304.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-159113, filed Sep. 13, 2024, which is hereby incorporated by reference herein in its entirety.

What is claimed is:

1. A fixing device configured to fix a toner image borne on a recording material to the recording material, the fixing device comprising:
an endless rotatable belt;
a nip portion forming member configured to be brought into contact with an outer peripheral surface of the belt to form a nip portion that nips and conveys the recording material between the nip portion forming member and the belt;
a sliding member configured to slide on an inner peripheral surface of the belt in the nip portion; and
a holding member disposed inside the belt so as to sandwich the sliding member and the belt between the holding member and the nip portion forming member, the holding member having a recess for holding the sliding member on a side facing the nip portion,
wherein the nip portion forming member is configured to be movable between a contacting position where the nip portion forming member is in contact with the outer peripheral surface of the belt to form the nip portion and a separated position where the nip portion forming member is separated from the outer peripheral surface of the belt,
the recess includes a bottom surface, and a downstream side surface formed downstream of the bottom surface in a conveyance direction of the recording material conveyed in the nip portion and facing a downstream end surface in the conveyance direction of the sliding member held in the recess,
the sliding member is configured to be held by the holding member so as to be movable in a direction away from the bottom surface in a state where the nip portion forming member is at the separated position,
the holding member has a protrusion portion protruding toward the nip portion at a position upstream of the downstream side surface of the recess in the conveyance direction, and
a lowermost point of the protrusion portion is closer to the nip portion than a surface of the sliding member facing the bottom surface in the state where the nip portion forming member is at the separated position.

2. The fixing device according to claim 1, wherein
the protrusion portion protrudes toward the nip portion at a position upstream of the downstream side surface of the recess in the conveyance direction, and does not protrude toward the nip portion beyond the sliding member in a state where the nip portion forming member is located at the contacting position.

3. The fixing device according to claim 1, wherein
the sliding member has a contact portion disposed upstream of the protrusion portion in the conveyance direction, and is brought into contact with the protrusion portion, in a state where the nip portion forming member is located at the separated position, to restrict the sliding member from moving downstream in the conveyance direction.

4. The fixing device according to claim 1, wherein
the downstream end surface and the downstream side surface of the recess are brought into contact with each other, in a state where the nip portion forming member is located at the contacting position, to restrict the sliding member from moving downstream in the conveyance direction.

5. The fixing device according to claim 3, wherein
the sliding member has a cut-out portion cut out upstream in the conveyance direction from a downstream end,
the contact portion is a part of the cut-out portion, and
the protrusion portion is located downstream of the part of the cut-out portion in the conveyance direction.

6. The fixing device according to claim 5, wherein
the cut-out portion is formed at a downstream end portion in the conveyance direction and at an end portion in a width direction intersecting the conveyance direction of the sliding member.

7. The fixing device according to claim 6, wherein
the protrusion portion is provided at an end portion of the holding member in the width direction.

8. The fixing device according to claim 1, wherein
the holding member has a downstream side guide surface formed downstream of the downstream side surface of the recess in the conveyance direction to guide the belt downstream in a rotation direction of the belt, and
a height of the protrusion portion from the bottom surface is larger than a height of an upstream end of the downstream side guide surface in the conveyance direction from the bottom surface.

9. The fixing device according to claim 1, further comprising:
a support member disposed on a side opposite to the nip portion with the holding member interposed therebetween to support the holding member; and
a fastening member configured to fasten the sliding member to the support member with a gap in a height direction orthogonal to the conveyance direction and orthogonal to a width direction intersecting the conveyance direction.

10. The fixing device according to claim 9, wherein
the fastening member fastens the sliding member to the support member with a gap in each of the conveyance direction and the width direction.

11. The fixing device according to claim 1, wherein
the protrusion portion is provided outside a region where a recording material having a maximum size passes through the nip portion in a width direction intersecting the conveyance direction.

12. The fixing device according to claim 1, wherein
the sliding member has a plurality of projections provided on a side sliding against the belt so as to protrude toward the inner peripheral surface of the belt.

13. The fixing device according to claim 12, wherein
the holding member has a downstream side guide surface formed downstream of the downstream side surface of the recess in the conveyance direction to guide the belt downstream in a rotation direction of the belt, and
the protrusion portion is formed so as not to come into contact with the inner peripheral surface of the belt stretched between the plurality of projections and the downstream side guide surface in a state where the nip portion forming member is located at the contacting position.

14. The fixing device according to claim 12, wherein
the sliding member has a contact portion disposed upstream of the protrusion portion in the conveyance direction, and is brought into contact with the protrusion portion, in a state where the nip portion forming member is located at the separated position, to restrict the sliding member from moving downstream in the conveyance direction, and
the contact portion is provided outside a region where the plurality of projections are formed in a width direction intersecting the conveyance direction.

15. The fixing device according to claim 1, wherein
the nip portion forming member is a pressure roller configured to pressurize the belt toward the sliding member.

16. The fixing device according to claim 1, further comprising:
a heating roller contacting the inner peripheral surface of the belt; and
a heat source configured to heat the heating roller.

17. The fixing device according to claim 1, wherein
the sliding member is made of metal.

18. The fixing device according to claim 1, wherein
the belt rotates in the conveyance direction at the separated position.
